(19) United States
(12) Patent Application Publication
(10) Pub. No.: US 2025/0306536 A1
(43) Pub. Date: Oct. 2, 2025

(54) TIMEPIECE PART, MOVEMENT, TIMEPIECE EXTERIOR, TIMEPIECE, AND METHOD FOR MANUFACTURING TIMEPIECE PART

(71) Applicant: SEIKO WATCH KABUSHIKI KAISHA (trading as SEIKO WATCH CORPORATION), Tokyo (JP)

(72) Inventors: Natsuki MIYOSHI, Tokyo (JP); Koichiro JUJO, Tokyo (JP)

(21) Appl. No.: 19/088,511

(22) Filed: Mar. 24, 2025

(30) Foreign Application Priority Data
Mar. 28, 2024 (JP) 2024-054580

(51) Int. Cl. G04B 45/00; G04D 3/00

(52) U.S. Cl. CPC G04B 45/0076; G04D 3/0074

(57) ABSTRACT

Provided are a timepiece part, a movement, a timepiece exterior, a timepiece, and a method for manufacturing a timepiece part, which can obtain a novel visual effect. The timepiece part includes: a base material containing copper; and a denatured film disposed on the base material, in which the denatured film contains a bubble.

### RELATED APPLICATIONS

This application claims priority to Japanese Patent application No. JP2024-0054580, filed on Mar. 28, 2024, the entire content of which is incorporated herein by reference.

### BACKGROUND OF THE INVENTION

### 1. Field of the Invention

The present disclosure relates to a timepiece part, a movement, a timepiece exterior, a timepiece, and a method for manufacturing a timepiece part.

### 2. Description of Related Art

In order to increase an added value of a timepiece from an aesthetic viewpoint, parts constituting the timepiece may be colored in a desired color. For example, JP2012-127877A describes a method for applying various colors different from an original metal color by forming an oxide film on a timepiece part containing titanium by anodizing.

As a method for applying a color tone different from that of a base material to a surface of the base material containing a metal, there are various methods depending on a type of the metal. For example, as a method for applying a color tone different from that of a base material to a surface of the base material containing copper, a Japanese traditional craft technique called a boiling color is known (see Junko Imabuchi, etc., “Surface Coloring of Metallic Arts and Crafts” surface technique, Vol. 51, No. 10, 2000, pp 18-24).

A method for chemically modifying and coloring the surface of the base material containing a metal has advantages in that, for example, a thickness of a film formed by denaturation is thin and an influence on the dimensional accuracy of a part is small, and durability and fastness are excellent, as compared with a method for forming a film using a paint. On the other hand, a film formed by chemically modifying a surface of a base material obtained by a known technique tends to have a homogeneous composition, has a poor visual effect due to reflection or interference of light incident on the film, and tends to have a monotonic appearance.

### SUMMARY OF THE INVENTION

It is an aspect of the present application to provide a timepiece part, a movement, a timepiece exterior, a timepiece, and a method for manufacturing a timepiece part, which can obtain a novel visual effect.

A method for solving the above problems includes the following embodiments.

<1> A timepiece part including: a base material containing copper; and a denatured film disposed on the base material, in which the denatured film contains a bubble.

<2> The timepiece part according to <1>, in which a size of the bubbles is 5 nm or more and 500 nm or less.

<3> The timepiece part according to <1> or <2>, in which the number of bubbles is 1/μm2 or more and 50/μm2 or less.

<4> The timepiece part according to any one of <1> to <3>, in which a thickness of the denatured film is 0.1 μm or more and 20 μm or less.

<5> A movement including: the timepiece part according to any one of <1> to <4>.

<6> A timepiece exterior including: the timepiece part according to any one of <1> to <4>.

<7> A timepiece including: the timepiece part according to any one of <1> to <4>.

<8> A method for manufacturing a timepiece part, which is a method for manufacturing the timepiece part according to any one of <1> to <4>, the method including: stirring an aqueous solution containing copper sulfate and verdigris in a state where the base material containing copper is immersed in the aqueous solution.

According to the disclosure, a timepiece part, a movement, a timepiece exterior, a timepiece, and a method for manufacturing a timepiece part, which can obtain a novel visual effect, are provided.

### BRIEF DESCRIPTION OF THE DRAWINGS

FIG. 1 is a plan view schematically showing an example of a timepiece part according to an embodiment of the disclosure.

FIG. 2 is a diagram schematically showing an example of a timepiece according to the embodiment of the disclosure.

FIGS. 3A, 3B, 3C and 3D are diagrams schematically showing an example of a method for manufacturing the timepiece part according to the embodiment of the disclosure.

FIG. 4 is an image of a cross section of a test piece prepared in Examples.

### DETAILED DESCRIPTION OF THE PREFERRED EMBODIMENTS

Hereinafter, embodiments of the disclosure will be described. In the present specification, when there is a numerical range expressed using “to”, the numerical range means a range including numerical values described before and after “to” as a lower limit value and an upper limit value.

### First Embodiment

A first embodiment of the disclosure is a timepiece part including a base material containing copper and a denatured film disposed on the base material, in which the denatured film contains a bubble.

In the disclosure, the “denatured film” disposed on the base material constituting the timepiece part means a film (layer) formed by chemically changing a component contained in the base material. That is, a film formed using a material different from the base material such as a paint or a plating does not correspond to a “denatured film”.

In the timepiece part according to the first embodiment, the denatured film disposed on a surface of the base material contains the bubble. Therefore, as compared with a case where a denatured film disposed on a surface of a base material does not contain a bubble, a complicated color tone is exhibited, and a visual effect which is not seen in a timepiece part in the related art can be provided to an observer.

Further, the denatured film disposed on the surface of the base material exhibits a remarkable coloring effect even when the thickness is thin. Therefore, a desired visual effect can be obtained without impairing high dimensional accuracy required for the timepiece part.

The reason why the visual effect given to the observer differs between the case where the denatured film formed on the surface of the base material contains a bubble and the case where the denatured film does not contain a bubble is considered as follows.

When light is incident on the denatured film formed on the surface of the base material, reflection of the light on an interface between the base material and the denatured film and interference of the light in the denatured film are generated. As a result, the denatured film exhibits a color tone different from that of the base material.

When the denatured film on which the light is incident contains a bubble, in addition to the reflection of the light on the interface between the base material and the denatured film and the interference of the light in the denatured film, irregular reflection of the light is generated around the bubble existing in the denatured film. Further, when bubbles are dispersed in the denatured film, a depth at which irregular reflection is generated varies depending on positions of the bubbles. It is considered that the color tone of the denatured film becomes complicated due to the action of the irregular reflection generated around the bubbles.

The base material provided in the timepiece part according to the first embodiment is not particularly limited as long as the base material contains copper and can form a denatured film on the surface. That is, the base material provided in the timepiece part according to the first embodiment may contain pure copper or various copper alloys. By selecting a material of the base material, a desired color tone can be given to the timepiece part.

In the disclosure, the “base material containing copper” includes a case where the whole base material contains copper and a case where a part of the base material contains copper. When a part of the base material contains copper, it is preferable that at least the surface of the base material contains copper.

In the disclosure, the “copper alloy” means an alloy containing copper as a main component (component whose content is the highest).

A content of copper in the base material (when a part of the base material contains copper, the part) may be, for example, 50% by mass or more, 70% by mass or more, or 80% by mass or more.

Specific examples of the copper alloy that can be used as the base material include a CuAg alloy (shibuichi), a CuAu alloy (shakudo or purple gold), a CuAs alloy (black copper), a CuZn alloy (brass), a CuNi alloy (white copper), a CuZnNiMn alloy (nickel silver), a CuSn alloy (bronze), a CuSnP alloy (phosphor bronze), a CuAl alloy (aluminum bronze), and a CuBe alloy (beryllium copper).

In the timepiece part according to the first embodiment, a thickness of the denatured film disposed on the surface of the base material is not particularly limited.

From the viewpoint of sufficiently exhibiting the coloring effect by the formation of the denatured film, the thickness of the denatured film may be 0.1 μm or more.

From the viewpoint of ensuring the dimensional accuracy of the timepiece part, the thickness of the denatured film may be 20 μm or less.

In the disclosure, the thickness of the denatured film is measured by observing a cross section of the denatured film using an electron microscope or the like. When the thickness of the denatured film is not uniform, an average value of the thicknesses of the denatured films measured at 10 or more cross sections of the denatured films is defined as the thickness of the denatured film.

In the timepiece part according to the first embodiment, a size of the bubble contained in the denatured film disposed on the surface of the base material is not particularly limited.

From the viewpoint of sufficiently exhibiting the visual effect due to the irregular reflection of the light generated around the bubble, the size of the bubbles may be 5 nm or more, 10 nm or more, or 50 nm or more.

An upper limit value of the size of the bubble is not particularly limited, and may be, for example, 500 nm or less, 200 nm or less, or 100 nm or less.

In the disclosure, the size of the bubble contained in the denatured film is set as a maximum diameter of the bubble measured by observing the cross section of the denatured film using an electron microscope or the like. When the size of the bubble observed on the cross section of the denatured film is not constant, an average value of the sizes of 10 or more bubbles observed on the cross section of the denatured film is defined as the size of the bubble.

In the timepiece part according to the first embodiment, the number of bubbles contained in the denatured film disposed on the surface of the base material is not particularly limited.

From the viewpoint of sufficiently exhibiting the visual effect due to the irregular reflection of the light generated around the bubbles, the number of bubbles may be 1/μm2 or more, 2/μm2 or more, or 5/μm2 or more.

An upper limit value of the number of bubbles is not particularly limited, and may be, for example, 50/μm2 or less, 20/μm2 or less, or 10/μm2 or less.

In the disclosure, the number of bubbles contained in the denatured film is the number of bubbles per 1 μm2 measured by observing the cross section of the denatured film using an electron microscope or the like. When a distribution of the bubbles observed on the cross section of the denatured film is not uniform, an average value of the number of bubbles observed in a region of 4 μm2 or more is defined as the number of bubbles. From the viewpoint of measurement accuracy, the average value of the numbers of bubbles measured from the cross sections of the denatured films obtained at a plurality of positions (for example, 10 positions) may be used as the number of bubbles.

The timepiece part according to the first embodiment may be subjected to surface processing other than the formation of the denatured film.

Examples of the surface processing other than the formation of the denatured film include engraving, forging, patterning, woodgrain molding, inlaying, roughening, mirror finishing, coating of a paint such as a varnish, and plating using a different material.

As a specific technique of the engraving, there is a technique of forming a design on a surface of a base material by a cut trace by a cutting tool or an indentation by a burin.

As a specific technique of the forging, there is a technique of forming a design on a surface of a base material by a hit trace by a hammer.

As a specific technique of the inlaying, there is a technique of engraving a surface of a base material and inlaying a metal different from the base material into the surface.

As a specific technique of the patterning, there is a technique of pressing a sandpaper, a rubber-like grindstone, or the like to provide regular grinding traces on a surface of a base material, and a technique of providing regular cut traces on a surface of a base material by milling or the like.

As a specific technique of the woodgrain molding, there is a technique of laminating layers containing different types of metals and exposing the lower metal in a wood grain shape on a surface.

As a specific technique of the roughening or the mirror finishing, there is etching, sand blasting, honing, polishing, or the like.

The surface processing may be performed on the entire surface of the timepiece part (however, except for coating of a paint or plating) or on a part of the surface.

The surface processing may be performed before the denatured film is formed on the surface of the base material or after the denatured film is formed on the surface of the base material.

The type of the timepiece part according to the first embodiment is not particularly limited. Examples of a suitable part as the timepiece part of the disclosure include a dial, a hand, a dial ring (a part placed on an outer peripheral portion of the dial to hide a gap between a case and the dial), a main plate, a bridge (a member for fixing a part mounted on the main plate), a body of oscillating weight (a member for holding a weight and fixed via a bearing or the like), and an indication plate such as a date indicator.

Since the timepiece part according to the first embodiment has an excellent visual effect, the timepiece part is preferably a part that can be observed by a user of the timepiece.

In the timepiece part according to the first embodiment, since the base material contains copper and is relatively soft, the timepiece part is preferably a part incorporated in a case of the timepiece.

### Second Embodiment

A second embodiment of the disclosure is a movement, a timepiece exterior, or a timepiece including the timepiece part according to the first embodiment described above.

That is, at least one of the parts constituting the movement, the timepiece exterior, or the timepiece according to the second embodiment includes a base material containing copper and a denatured film containing a bubble disposed thereon.

In the disclosure, the “movement” means a mechanical body including a driving portion of a timepiece, and the “timepiece exterior” means parts other than the movement among the parts constituting the timepiece. Specific examples of the timepiece exterior include a case, a dial (including an index), a hand, a dial ring, a metal bracelet, a clasp (a clasp for a leather bracelet), a buckle (a clasp for a metal bracelet), a crown, and a button.

In the movement, the timepiece exterior, or the timepiece according to the second embodiment, at least one part selected from the dial, the hand, the dial ring, the main plate, the bridge, the body of oscillating weight, and the indication plate such as a date indicator is preferably the timepiece part according to the first embodiment.

As an example of the timepiece according to the second embodiment, a structure of a mechanical wrist timepiece will be described with reference to the drawings. In the following description, a machine body including a driving portion of the timepiece is referred to as a “movement”. A state where a dial and hands are attached to the movement and the obtained product is put into a case to form a finished product is referred to as a “complete” timepiece.

In the following description, a side on which a complete dial is observed is referred to as a “front side”, and a side on which the complete dial is not observed is referred to as a “back side”.

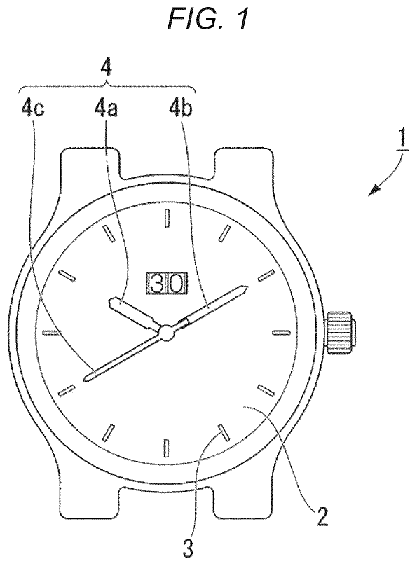

FIG. 1 is a plan view showing an example of a configuration of a complete observed from the front side. A complete 1 includes a dial 2 on which indicators 3 or the like indicating information related to an hour are arranged, and hands 4 indicating a time. The hands 4 include an hour hand 4a, a minute hand 4b, and a second hand 4c.

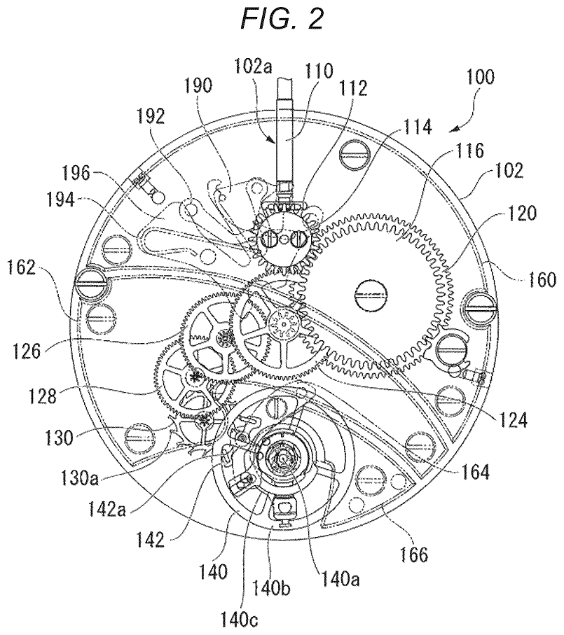

FIG. 2 is a plan view showing an example of a configuration of the complete observed from the back side. In FIG. 2, in order to make the drawing easy to see, illustration of a part of timepiece parts constituting a movement 100 is omitted.

The movement 100 includes a main plate 102 as a base plate on which parts are mounted. A winding stem 110 is rotatably incorporated in a winding stem guide hole 102a of the main plate 102. A position of the winding stem 110 in an axial direction is determined by a switching device including a setting lever 190, a yoke 192, a yoke spring 194, and a setting lever jumper 196.

When the winding stem 110 is rotated, a winding pinion 112 is rotated via rotation of a clutch wheel (not shown). By the rotation of the winding pinion 112, a crown wheel 114 and a ratchet wheel 116 are rotated in this order, and a mainspring (not shown) accommodated in a movement barrel complete 120 is wound up.

The movement barrel complete 120 is rotatably supported between the main plate 102 and a barrel bridge 160. A center wheel and pinion 124, a third wheel and pinion 126, a second wheel and pinion 128, and an escape wheel and pinion 130 are rotatably supported between the main plate 102 and a train wheel bridge 162. A pallet fork 142 is rotatably supported between the main plate 102 and a pallet bridge 164.

The movement barrel complete 120 rotates by a restoring force of the mainspring. By the rotation of the movement barrel complete 120, the center wheel and pinion 124, the third wheel and pinion 126, the second wheel and pinion 128, and the escape wheel and pinion 130 rotate in this order. The movement barrel complete 120, the center wheel and pinion 124, the third wheel and pinion 126, and the second wheel and pinion 128 constitute a front train wheel. An escapement and regulating device for controlling the rotation of the front train wheel includes the escape wheel and pinion 130, the pallet fork 142, and a balance with hairspring 140. Teeth 130a are formed on an outer periphery of the escape wheel and pinion 130. The pallet fork 142 includes a pair of pallets 142a. The balance with hairspring 140 includes a balance staff 140a, a balance wheel 140b, and a hairspring 140c.

In a state where one pallet 142a of the pallet fork 142 is engaged with the teeth 130a of the escape wheel and pinion 130, the escape wheel and pinion 130 temporarily stops. From this state, when the balance with hairspring 140 is rotated by the expansion and contraction of the hairspring 140c, an impulse pin fixed to the balance staff 140a swings up the pallet fork 142. Accordingly, one pallet 142a of the pallet fork 142 is disengaged from the escape wheel and pinion 130, and the escape wheel and pinion 130 advances to a position where the escape wheel and pinion 130 engages with the other pallet 142a of the pallet fork 142. The balance with hairspring 140 reciprocates in a constant cycle, and thus, it is possible to make the escape wheel and pinion 130 escape at a constant speed.

When the center wheel and pinion 124 rotates, a cannon pinion (not shown) rotates simultaneously based on the rotation, and the minute hand 4b (see FIG. 1) attached to the cannon pinion indicates “minute”. In addition, an hour wheel (not shown) is rotated by rotation of a minute wheel based on the rotation of the cannon pinion, and the hour hand 4a (see FIG. 1) attached to the hour wheel indicates “hour”.

In the timepiece according to the second embodiment, for example, at least one part selected from the dial 2, the main plate 102, the barrel bridge 160, the train wheel bridge 162, or the pallet bridge 164 of the wrist timepiece shown in FIGS. 1 and 2 includes a base material containing copper and a denatured film containing a bubble disposed thereon.

The timepiece shown in FIGS. 1 and 2 is a mechanical timepiece, but the timepiece according to the second embodiment is not limited to the mechanical timepiece, and may be a quartz timepiece, a solar timepiece, a radio timepiece, or the like.

The timepiece shown in FIGS. 1 and 2 is a wrist timepiece, but the timepiece according to the second embodiment is not limited to the wrist timepiece, and may be a pocket timepiece, a table timepiece, a wall timepiece, or the like.

The dial of the timepiece shown in FIGS. 1 and 2 may be opaque or transparent. A case back of the timepiece may be opaque or transparent.

### Third Embodiment

A third embodiment of the disclosure is a method for manufacturing the timepiece part according to the first embodiment described above, the method including stirring an aqueous solution containing copper sulfate and verdigris in a state where a base material containing copper is immersed in the aqueous solution.

According to the method of the third embodiment, a denatured film containing a bubble can be formed on a surface of a base material containing copper. Therefore, it is possible to obtain a timepiece part exhibiting a novel visual effect.

According to the method of the third embodiment, a denatured film (oxide film) containing cuprous oxide is formed on the surface of the base material.

A content of copper sulfate contained in the aqueous solution used in the method of the third embodiment can be selected from, for example, a range of 1 g to 20 g per liter of water.

A content of verdigris contained in the aqueous solution used in the method of the third embodiment can be selected from, for example, a range of 1 g to 20 g per liter of water.

If necessary, the aqueous solution may contain components other than copper sulfate and verdigris.

When the aqueous solution is stirred in the state where the base material containing copper is immersed in the aqueous solution containing copper sulfate and verdigris, a temperature of the aqueous solution can be selected from a range of, for example, 60° C. to 100° C.

A time, for which the aqueous solution is stirred in the state where the base material containing copper is immersed in the aqueous solution containing copper sulfate and verdigris, can be selected from a range of, for example, 30 minutes to 5 hours. The stirring method is not particularly limited as long as the denatured film containing a bubble is formed on the surface of the base material. The stirring may be continued from the start to the end of the immersion of the base material in the aqueous solution or may be performed after a pause period.

The method according to the third embodiment may include applying surface processing other than the formation of the denatured film to the timepiece part.

Examples of the surface processing other than the formation of the denatured film include engraving, forging, patterning, woodgrain molding, inlaying, roughening, mirror finishing, coating of a paint such as a varnish, and plating using a different material.

The surface processing may be performed on the entire surface of the timepiece part (however, except for coating of a paint or plating) or on a part of the surface.

The surface processing may be performed before the denatured film is formed on the surface of the base material or after the denatured film is formed on the surface of the base material.

The base material before being immersed in the aqueous solution containing copper sulfate and verdigris (that is, before the denatured film is formed on the surface) is processed into a predetermined timepiece part shape.

The processing method is not particularly limited, and examples thereof include casting, forging, cutting, pressing, and 3D shaping.

When a part of the base material contains copper, the base material may be obtained by forming a film containing copper on a surface of an object not containing copper by plating or the like.

The method for processing the base material may be electrocasting. The electrocasting is suitable as a method for processing a part having a fine shape. In the disclosure, the electrocasting means a method for removing a base member from a metal layer formed on a surface of the base member by electrolytic plating and using the metal layer from which the base member is removed as a product.

The base material manufactured by the electrocasting may have a desired shape. Such a base material can be obtained by, for example, a method for combining photolithography, which is referred to as “LIGA”, and electrolytic plating.

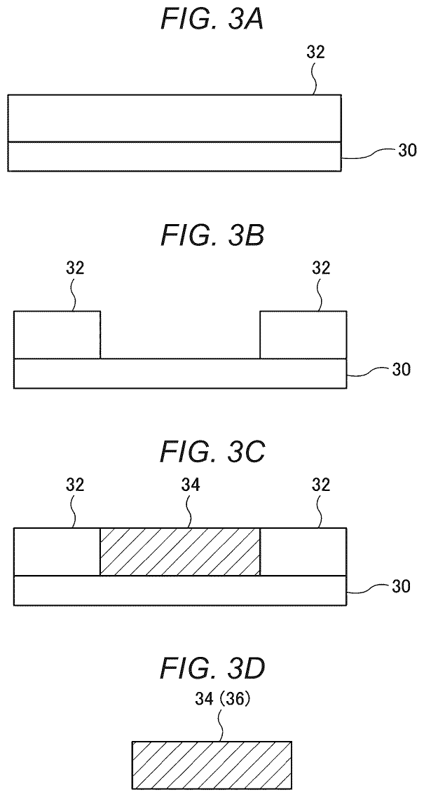

Specifically, a metal member having a desired shape can be obtained by performing steps shown in FIG. 3A to FIG. 3D.

In the step of FIG. 3A, a photo resist layer 32 is formed on a surface of a base member 30 whose surface has conductivity at least. As a photo resist used for forming the photo resist layer 32, any of a negative type photo resist whose solubility in a developing solution is reduced by exposure (that is, a state where the negative type photo resist cannot be removed by development) or a positive type photo resist whose solubility in a developing solution is increased by exposure (that is, a state where the positive type photo resist can be removed by development) can be applied. Hereinafter, a case where the negative type photo resist is used will be described.

In the step of FIG. 3B, the photo resist layer 32 is exposed in a pattern, and an unexposed portion of the photo resist layer 32 is removed by the developing solution. As light used for the exposure, an X-ray, an ultraviolet ray, or the like can be used without particular limitation.

In the step of FIG. 3C, the developed base member 30 is immersed in an aqueous solution of metal ions to perform electrolytic plating, thereby forming a metal layer 34 on a portion of the photo resist layer 32 where the unexposed portion is removed. If necessary, a treatment for adjusting a thickness of the metal layer 34, such as grinding or polishing, may be performed after the electrolytic plating.

In the step of FIG. 3D, the base member 30 and the photo resist layer 32 are removed from the metal layer 34 formed by the electrolytic plating, and the metal layer 34 having a shape corresponding to the unexposed portion of the photo resist layer 32 is obtained as a base material 36.

### Examples

Hereinafter, the disclosure will be described based on examples, but the disclosure is not limited thereto.

### (Treatment of Test Piece)

A test piece made of shakudo was prepared as a base material containing copper.

The test piece was immersed in an aqueous solution (80° C.) containing copper sulfate (3 g/liter) and verdigris (3 g/liter), and the immersion was continued for 1 hour while stirring the aqueous solution. Thereafter, the test piece was taken out from the aqueous solution and dried.

The test piece after the treatment exhibited a color tone different from that of the test piece before the immersion.

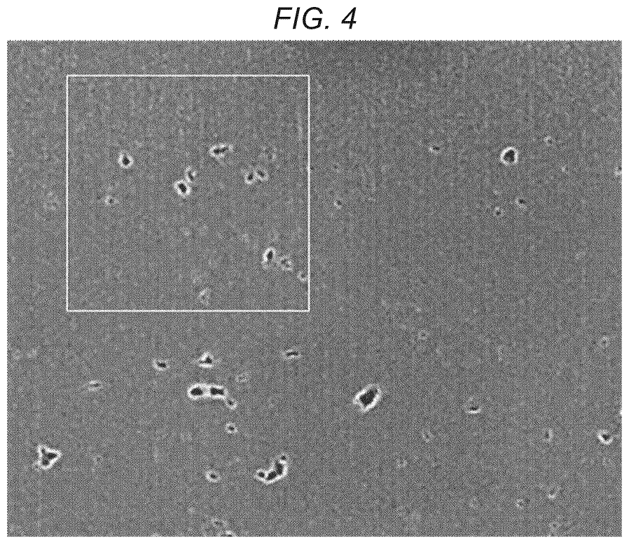

The test piece after the treatment was cut with a focused ion beam (FIB), and the cross section was observed with a scanning electron microscope (SEM), and thus a denatured film (oxide film) having a thickness of about 3 μm was formed on the surface of the base material. An SEM image of the observed denatured film is shown in FIG. 4. A size of a portion surrounded by the frame in the drawing is 1 μm×1 μm. As shown in FIG. 4, the denatured film formed on the surface of the base material contained bubbles therein.

What is claimed is:

1. A timepiece part comprising:
a base material containing copper; and
a denatured film disposed on the base material, wherein
the denatured film contains a bubble.

2. The timepiece part according to claim 1, wherein
a size of the bubbles is 5 nm or more and 500 nm or less.

3. The timepiece part according to claim 1, wherein
the number of bubbles is 1/μm2 or more and 50/μm2 or less.

4. The timepiece part according to claim 1, wherein
a thickness of the denatured film is 0.1 μm or more and 20 μm or less.

5. A movement comprising:
the timepiece part according to claim 1.

6. A timepiece exterior comprising:
the timepiece part according to claim 1.

7. A timepiece comprising:
the timepiece part according to claim 1.

8. A method for manufacturing a timepiece part, which is a method for manufacturing the timepiece part according to claim 1, the method comprising:
stirring an aqueous solution containing copper sulfate and verdigris in a state where the base material containing copper is immersed in the aqueous solution.
